(19) United States
(12) Patent Application Publication
(10) Pub. No.: US 2010/0038936 A1
(43) Pub. Date: Feb. 18, 2010

(54) CLAMPING APPARATUS

(76) Inventors: Ashley Craig Gibson, Wellington (NZ); Campbell Gower, Wellington (NZ)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/504,472

(22) Filed: Jul. 16, 2009

Related U.S. Application Data
(60) Provisional application No. 61/081,128, filed on Aug. 15, 2008.

(51) Int. Cl. A47D 1/10; B25B 5/06

(52) U.S. Cl. 297/174 CS; 269/229

(57) ABSTRACT

A clamping apparatus has a first jaw, an elongate bar, a second jaw. A driving lever is selectively engageable with the bar to move the first jaw in a first direction relative to the second jaw. A braking lever normally engages the bar to prevent the first jaw from moving in a second direction and, when disengaged, enables the first jaw to move in the second direction. A safety lock when in a locked configuration prevents disengagement of the braking lever from the elongate bar. As the safety lock changes from the released configuration to the locked configuration, the safety lock causes engagement of the driving lever on the elongate bar, causing movement of the first jaw in the first direction relative to the second jaw. A table-mountable chair comprises two of the clamping apparatuses.

This application claims the priority benefit of U.S. Provisional Application No. 61/081,128, filed Aug. 15, 2008, the entire contents of which are hereby incorporated by reference herein.

### FIELD

One embodiment of the invention relates to an apparatus for clamping one or more items. For some embodiments, the invention also relates to a portable chair that is suitable for mounting to a table, which incorporates clamping apparatuses to mount the chair to a table top.

### BACKGROUND

A high chair is used to support a young child, generally while they are eating. It is desirable to have the child sitting at a similar height to a seated adult for two reasons. First, it enables the adult to easily attend to the child while they are eating. Second, it enables easy interaction and socialising between the adult and child.

Conventional high chairs stand on the floor. While collapsible high chairs are available, they still take up a significant amount of space when they are not being used, as by necessity they must stand tall enough that the child is supported at a suitable height. Also, they are generally awkward to move around.

More recently, a portable high chair has been available that mounts directly to a table top rather than being supported from the ground. That is the ME TOO chair sold by Phil and Teds Most Excellent Buggy Company of Wellington, New Zealand. That chair has manual winders that are used to mount the chair to a table top. That is somewhat time-consuming.

It is an object of at least preferred embodiments of the invention to provide a table-mountable chair that incorporates clamping apparatuses that enable the chair to be readily mounted to a table top, but that are unlikely to be inadvertently released. It is an alternative object of at least preferred embodiments of the present invention to provide an apparatus for clamping one or more objects that is unlikely to be inadvertently released. It is an alternative object of at least preferred embodiments of the present invention to provide the public with a useful alternative.

In this specification, where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

### SUMMARY

The term “comprising” as used in this specification means “consisting at least in part of.” When interpreting each statement in this specification that includes the term “comprising,” features other than that or those prefaced by the term may also be present. Related terms such as “comprise” and “comprises” are to be interpreted in the same manner.

In a first aspect, the invention may be said broadly to consist in an apparatus for clamping one or more objects, the apparatus comprising:

a support;

a first jaw mounted to the support;

an elongate bar;

a second jaw mounted to the elongate bar, wherein the elongate bar is slidable relative to the support to move the first jaw and second jaw toward one another or away from one another;

a driving lever supported by the support and that is selectively engageable with the elongate bar and that, when engaged, moves the first jaw in a first direction relative to the second jaw;

a braking lever supported by the support and that normally engages the elongate bar and that, when engaged, prevents the first jaw from moving in a second direction opposite to said first direction relative to the second jaw and that, when disengaged, enables the first jaw to move in said second direction relative to the second jaw;

a driving actuator that operatively engages the driving lever such that when the driving actuator is operated by a user, the driving lever engages the elongate bar and causes movement of the first jaw in the first direction relative to the second jaw;

a brake release actuator that operatively engages the braking lever such that when the brake release actuator is operated by a user, the braking lever disengages the elongate bar and enables the first jaw to move in said second direction relative to the second jaw; and

a safety lock having a locked configuration and released configuration, the safety lock when in the locked configuration preventing disengagement of the braking lever from the elongate bar, and being configured such that as the safety lock changes from the released configuration to the locked configuration, the safety lock causes engagement of the driving lever on the elongate bar, thereby causing movement of the first jaw in the first direction relative to the second jaw.

Preferably, the first and second jaws are in opposed relationship, with an object-engaging face of the first jaw facing toward an object-engaging face of the second jaw. In such a configuration, the first direction will be relative movement of the jaws toward one another, and the second direction will be relative movement of the jaws away from one another.

In an alternative configuration, the first and second jaws may be outwardly directed relative to one another, with an object-engaging face of the first jaw facing away from an object-engaging face of the second jaw. This type of configuration is suitable when the apparatus is to clamp against two spaced apart object surfaces. In this configuration, the first direction will be relative movement of the jaws away from one another, and the second direction will be relative movement of the jaws toward one another.

The first jaw could be integrally formed with the support, such as via a polymer moulding or metal casting process for example. Alternatively, the first jaw could be formed separately from the support, and could be attached to the support. Similarly, the second jaw could be integrally formed with the elongate bar, such as via a polymer moulding or metal casting process for example. Alternatively, the second jaw could be formed separately from the elongate bar, and could be attached to the elongate bar.

The support may be in the form of a housing that contains at least some of the mechanism, and that is substantially enclosed. Alternatively, the support may be a more open configuration, such as a frame that supports the mechanism. Preferably, the driving actuator comprises at least one projection that engages the driving lever to actuate the driving lever such that it engages the elongate bar. More preferably, the driving actuator comprises two spaced apart projections that engage the driving lever to actuate the driving lever such that it engages the elongate bar, and the elongate bar extends through a spacing between the two projections.

The driving actuator preferably comprises a handle with a finger engagement portion sized to be engaged by a plurality of a user's fingers. The projection(s) is/are preferably positioned within the support, with the finger engagement portion of the handle positioned generally externally of the support. The finger engagement portion may be partly recessed in the support. The driving actuator is preferably pivoted to the support at a driving actuator pivot, with the finger engagement portion being positioned on one side of the pivot and the projection(s) being positioned on the other side of the pivot. Preferably, the support comprises a handle portion positioned relative to the driving actuator such that the handle portion may be positioned in the region of a user's hand between the user's thumb and forefinger, with at least some of the user's fingers extending generally around the finger engagement portion of the driving actuator to operate the driving actuator.

Preferably, the driving lever generally surrounds and is tiltable relative to the elongate bar. The configuration is preferably such that when the driving lever is generally perpendicular to the elongate direction of the elongate bar, the driving lever is disengaged from the bar, and when the driving lever is tilted relative to the elongate bar, the driving lever engages the elongate bar. The driving lever is preferably biased toward the disengaged configuration, and is caused to engage the bar by operation of the driving actuator. The driving lever is preferably biased by a spring, most preferably by a compression spring. However, it will be appreciated that any other type of biasing mechanism could be used, such as a leaf spring or torsion spring that biases the driving lever toward the disengaged configuration for example. Preferably, one end of the driving lever is pivoted to the support.

The driving lever may comprise two plates positioned on top of each other, rather than a single plate. The lever may be actuated in the same way as outlined herein, but having two driving plates will provide four grabbing points on the elongate bar rather than two grabbing points.

In the embodiment in which a spring biases the driving lever, the spring that biases the driving lever may also bias the driving actuator into its non-operated position, via the driving lever. Alternatively, or in addition, a driving actuator spring may be provided to bias the driving actuator into its non-operated position.

Preferably, the braking lever generally surrounds and is tiltable relative to the elongate bar. The configuration is preferably such that when the braking lever is generally perpendicular to the elongate direction of the elongate bar, the braking lever is disengaged from the bar, and when the braking lever is tilted relative to the elongate bar, the braking lever engages the elongate bar. The braking lever is preferably biased toward the engaged (tilted) configuration, and is caused to disengage the bar by operation of the brake release actuator. The braking lever is preferably biased by a spring, most preferably by a compression spring. However, it will be appreciated that any other type of biasing mechanism could be used, such as a leaf spring that biases the braking lever toward the engaged position for example. Preferably, one end of the braking lever is pivoted to the support.

The braking lever may comprise two plates positioned on top of each other, rather than a single plate. The lever may be actuated in the same way as outlined herein, but having two braking plates will provide four grabbing points on the elongate bar rather than two grabbing points.

Preferably, the safety lock comprises a cam member that is rotatably mounted to the support. The cam member preferably engages the braking lever such the braking lever cannot disengage the elongate bar, when the cam member is in the locked configuration. The cam member is preferably disengaged from the braking lever when the cam member is in the released configuration, so the brake release actuator can be actuated to release the braking lever from the elongate bar.

Preferably, the cam member engages with projection(s) of the driving actuator, and is configured such that the projection(s) of the driving actuator tilt the driving lever as the cam member moves to the locked configuration, to cause relative movement of the first and second jaws in the first direction. The configuration of the cam member, driving actuator, and driving lever are preferably such that the driving actuator can be used to selectively engage the driving lever with the elongate bar to move the jaws in the first direction relative to one another, whether the cam member is in the locked configuration or released configuration. Preferably, as the driving actuator is operated by a user, the projection(s) move out of contact with the cam member.

The cam member preferably comprises a first lobe that engages the braking lever in the locked configuration of the cam member, and a second lobe that engages the driving lever in the locked configuration of the cam member, when the driving actuator is not being operated.

The cam member is preferably positioned within the support between the driving lever and the braking lever.

The apparatus preferably comprises a safety lock actuator that is positioned generally externally of the housing, and that is operatively connected to the cam member. Preferably, the safety lock actuator comprises a lever that is operable by a user's forefinger when at least some of the user's remaining fingers generally surround a finger engagement portion of the driving actuator. The safety lock actuator may be in a position where it could alternatively be operable by a user's thumb when at least some of the user's fingers generally surround the finger engagement portion of the driving actuator.

The safety lock may be manually adjusted between the locked configuration and the released configuration, by a user operating the safety lock actuator. In an alternative embodiment, the safety lock may be biased into the locked configuration. That could be by any suitable type of biasing means, such as a torsion spring or other type of spring for example. In that alternative embodiment, the safety lock can be adjusted to the released configuration by the user operating the safety lock actuator, but will automatically return to the locked configuration under bias when the safety lock actuator is released.

The brake release actuator is preferably positioned such that it is operable by a user's thumb when the user's fingers generally surround the finger engagement portion of the driving actuator. Preferably, the brake release actuator is provided in a position away from the safety lock actuator. More preferably, the brake release actuator is provided in an upper surface of the support, the safety lock actuator is positioned in a side surface of the support, and the driving actuator is positioned in an under surface of the support. These directions should considered relative directions only, as it will be appreciated that the apparatus could be used in any suitable orientation.

Preferably, the driving actuator is provided with a non-operational portion against which force can be applied while operating the brake release actuator, without causing movement of the driving actuator. The non-operational portion is preferably provided immediately adjacent the housing, substantially directly beneath the pivot.

Preferably, the apparatus further comprises a brake release actuator safety mechanism or device that prevents the brake release actuator from being inadvertently operated. The brake release actuator safety mechanism may cause the brake release actuator to be biased into a position in which the brake release actuator cannot be operated, and may be manually moveable to a position in which the brake release actuator can be operated. Those correspond to a locking position and a released position of the brake release actuator safety mechanism respectively. Alternatively, the brake release actuator safety mechanism could comprise a cover that covers the brake release actuator, and at least a part of the cover could be moved to expose the brake release actuator. When the brake release actuator is exposed, that corresponds to a released position of the brake release actuator safety mechanism.

The brake release actuator safety mechanism may be separate from the brake release actuator. Alternatively, the safety mechanism may be integrated into the brake release actuator, such that sliding movement of the brake release actuator causes the brake release actuator to move to a position in which it can be operated.

Preferably, the apparatus is configured such that when the driving lever is disengaged from the elongate bar, the first jaw can be manually moved in the first direction relative to the second jaw. That enables a user to manually push the jaws in the first relative direction (such as toward one another in the case of inwardly facing opposed jaw surfaces) if they wish, rather than using the driving actuator.

The driving mechanism acts as a one-way drive mechanism, with actuation of the handle causing the jaws to move only in the first direction relative to one another.

The apparatus may be a stand alone device. For example, the apparatus may be a hand tool. More particularly, the apparatus may be a hand-held clamp for use in a workshop for example. Alternatively, the apparatus may be a substrate-mounted tool, such as a bench clamp for use in a workshop for example. In the case of a substrate-mounted tool, part of the apparatus (such as one of the jaws for example) may be formed by the substrate. Alternatively, the apparatus may be incorporated into another apparatus for mounting and used to mount that other apparatus to a support for example.

In a second aspect, the invention may also be said to broadly consist in a table-mountable high chair, comprising:

a seat portion for receiving and supporting a child;

and two mounting apparatuses for mounting the table-mounted chair to a table top, each mounting apparatus comprising an apparatus as outlined in relation to the first aspect above.

Therefore, in the second aspect, the invention may be said to broadly consist in a table-mountable chair, comprising:

a seat portion for receiving and supporting a child;

and two mounting apparatuses for mounting the table-mounted chair to a table top, each mounting apparatus comprising:
a support;
a first jaw mounted to the support;
an elongate bar;

a second jaw mounted to the elongate bar, wherein the elongate bar is slidable relative to the support to move the first jaw and second jaw toward one another or away from one another;
a driving lever supported by the support and that is selectively engageable with the elongate bar and that, when engaged, moves the first jaw toward the second jaw;
a braking lever supported by the support and that normally engages the elongate bar and that, when engaged, prevents the first jaw from moving away from the second jaw and that, when disengaged, enables the first jaw to move away from the second jaw;
a driving actuator that operatively engages the driving lever such that when the driving actuator is operated by a user, the driving lever engages the elongate bar and causes movement of the first jaw toward the second jaw;
a brake release actuator that operatively engages the braking lever such that when the brake release actuator is operated by a user, the braking lever disengages the elongate bar and enables the first jaw to move away from the second jaw; and
a safety lock having a locked configuration and released configuration, the safety lock when in the locked configuration preventing disengagement of the braking lever from the elongate bar, and being configured such that as the safety lock changes from the released configuration to the locked configuration, the safety lock causes engagement of the driving lever on the elongate bar, thereby causing movement of the first jaw toward the second jaw.

Preferably, the mounting apparatuses extend in a generally forward direction from the seat portion on respective sides thereof, with the jaws being forwardly open for receipt of a support surface such as a table top. Preferably, the driving actuators extend in a generally rearward direction. Preferably, the mounting apparatuses are positioned such that when a child is seated in the chair the child's legs are positioned under the table top.

The chair may be provided with any one or more of the features outlined in relation to the first aspect above.

In a third aspect, the invention may also be said to broadly consist in a method for supporting a table-mountable chair from a support surface such as a table top, the method comprising:

providing a table-mountable chair as outlined in relation to the second aspect above;

positioning said table-mountable chair relative to the support surface so that part of the support surface is positioned between the jaws of each mounting apparatus; and

operating the driving actuators of the mounting apparatuses so that the jaws capture said part of the support surface between the jaws.

Therefore, in the third aspect, the invention may be said to broadly consist in a method for supporting a table-mountable chair from a support surface such as a table top, the method comprising:

providing a table-mountable chair comprising:
a seat portion for receiving and supporting a child;

and two mounting apparatuses for mounting the table-mounted chair to a table top, each mounting apparatus comprising:
a support;
a first jaw mounted to the support;
an elongate bar;
a second jaw mounted to the elongate bar, wherein the elongate bar is slidable relative to the support to move the first jaw and second jaw toward one another or away from one another;
a driving lever supported by the support and that is selectively engageable with the elongate bar and that, when engaged, moves the first jaw toward the second jaw;
a braking lever supported by the support and that normally engages the elongate bar and that, when engaged, prevents the first jaw from moving away from the second jaw and that, when disengaged, enables the first jaw to move away from the second jaw;
a driving actuator that operatively engages the driving lever such that when the driving actuator is operated by a user, the driving lever engages the elongate bar and causes movement of the first jaw toward the second jaw;
a brake release actuator that operatively engages the braking lever such that when the brake release actuator is operated by a user, the braking lever disengages the elongate bar and enables the first jaw to move away from the second jaw; and
a safety lock having a locked configuration and released configuration, the safety lock when in the locked configuration preventing disengagement of the braking lever from the elongate bar, and being configured such that as the safety lock changes from the released configuration to the locked configuration, the safety lock causes engagement of the driving lever on the elongate bar, thereby causing movement of the first jaw toward the second jaw;
   the method further comprising:

positioning said table-mountable chair relative to the support surface so that part of the support surface is positioned between the jaws of each mounting apparatus; and

operating the driving actuators of the mounting apparatuses so that the jaws capture said part of the support surface between the jaws.

Preferably, the method further comprises adjusting the safety locks to the locked configuration. The step of adjusting the safety locks to the locked configuration may be carried out before, after, or during the step of adjusting the driving actuators to capture said part of the support between the jaws.

Preferably, the step of adjusting the safety locks to the locked configuration is carried out after actuation of the driving actuators to capture said part of the support surface between the jaws, and the step of adjusting the safety locks to the locked configuration causes the jaws to tighten further on said part of the support surface.

Preferably, the method further comprises placing a child in the seat portion of the table-mountable chair after the table-mountable chair has been mounted to the support surface.

Preferably, the method further comprises releasing the table-mountable chair from the support surface, by operating the brake release actuators. Preferably, the step of releasing the table-mountable chair from the support surface comprises initially adjusting the safety locks from the locked configuration to the released configuration. Preferably, the step of releasing the table-mountable chair further comprises releasing brake release actuator safety mechanisms, so that the brake release actuators can be operated.

The invention consists in the foregoing and also envisages constructions of which the following gives examples only.

### BRIEF DESCRIPTION OF THE DRAWINGS

The present invention is illustrated by way of example and not limitation in the figures of the accompanying drawings, in which like references indicate similar elements, and in which:

FIG. 1 is a front overhead perspective view of a preferred form table-mountable high chair incorporating the preferred form mounting apparatuses;

FIG. 2 is a side part sectional view of one of the preferred form mounting apparatuses of the chair of FIG. 1, with the safety lock disengaged and the driving actuator released;

FIG. 3 is a view similar to FIG. 2 with the safety lock disengaged and with the brake release actuator depressed to disengage the braking lever from the elongate member;

FIG. 4 is a view similar to FIG. 3 with the safety lock disengaged and the driving actuator partly compressed;

FIG. 5 is a view similar to FIG. 4, but with the safety lock disengaged and the driving actuator more fully compressed;

FIG. 6 is a view similar to FIG. 5, but with the safety lock disengaged and the driving actuator fully compressed;

FIG. 7 is a view similar to FIG. 6, but with the safety lock in the locked configuration in which it has caused tilting of the driving lever and engaged against the braking lever;

FIG. 8 is a view similar to FIG. 7, but with the safety lock in the locked configuration and with the driving actuator being compressed to cause tilting of the driving lever to cause the jaws to be moved toward one another;

FIG. 9 is a view similar to FIG. 8, but showing the safety lock during an initial movement from the released configuration toward the locked configuration, with the cam member of the safety lock engaging the projections of the driving actuator;

FIG. 10 is a view similar to FIG. 9, but with the cam member of the safety lock further engaged with the projections of the driving actuator which causes the projections to tilt the driving plate and move the jaws towards one another;

FIG. 11 is a view similar to FIG. 10, but with the cam member of the safety lock further rotated towards its locked configuration so that the cam member engages the braking lever;

FIG. 12 is a view similar to FIG. 11, but with the cam member of the safety lock having been rotated to the locked configuration in which it has fully engaged the braking lever and fully engaged the projections on the driving actuator;

FIG. 13 is a view similar to FIG. 12 and with the same configuration, but also showing that an attempted depression of the brake release actuator has no effect on the braking lever due to the engagement with the cam member;

FIG. 14a is a front perspective view of some of the components of the drive mechanism, showing the driving actuator in a released position, the safety lock in the released configuration, and the braking lever release actuator when not operated;

FIG. 14b is a rear overhead perspective view that otherwise corresponds to FIG. 14a;

FIG. 15a is a front overhead perspective view similar to FIG. 14a, but with the safety lock in the locked configuration;

FIG. 15b is a rear perspective view similar to FIG. 15a;

FIG. 16a is a front underside perspective view similar to FIG. 15a, but with the driving handle fully compressed;

FIG. 16b is a rear overhead perspective view similar to FIG. 16a;

FIG. 17 is a perspective view of the cam member;

FIG. 18a is an overhead perspective exploded view showing features of the brake release actuator safety mechanism;

FIG. 18b is an underside perspective view of the features of FIG. 18a;

FIG. 19a is an underside perspective view of the driving actuator, showing the non-operational portion;

FIG. 19b is a side view showing the position of the non-operational portion relative to the driving actuator pivot;

FIGS. 20a and 20b are perspective and side views respectively of an alternative preferred form elongate bar for use in the mounting apparatuses;

FIG. 21 is a perspective view of part of an alternative preferred form mounting apparatus; and

FIG. 22 is a perspective view of the mounting apparatus of FIG. 21.

### DETAILED DESCRIPTION

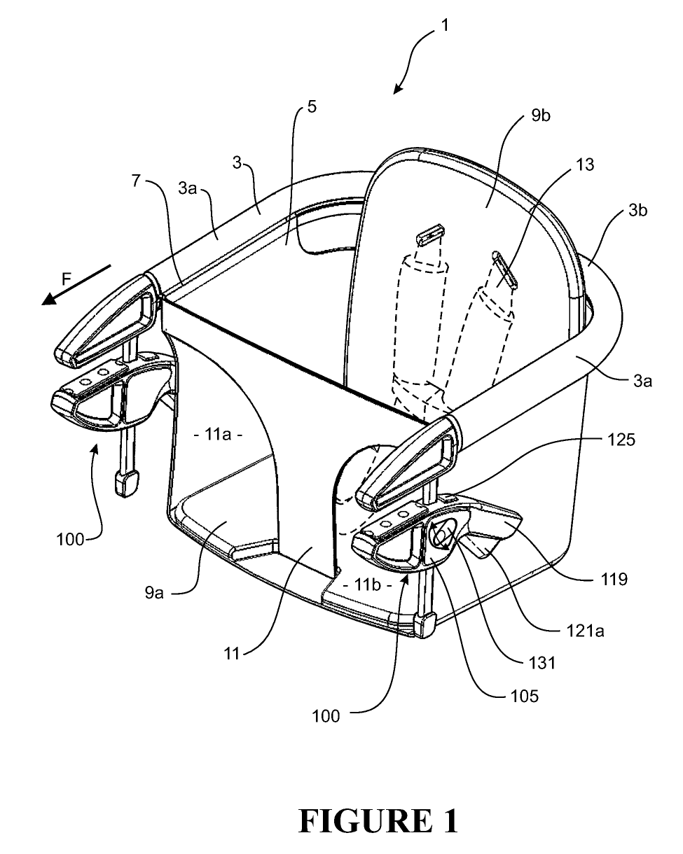

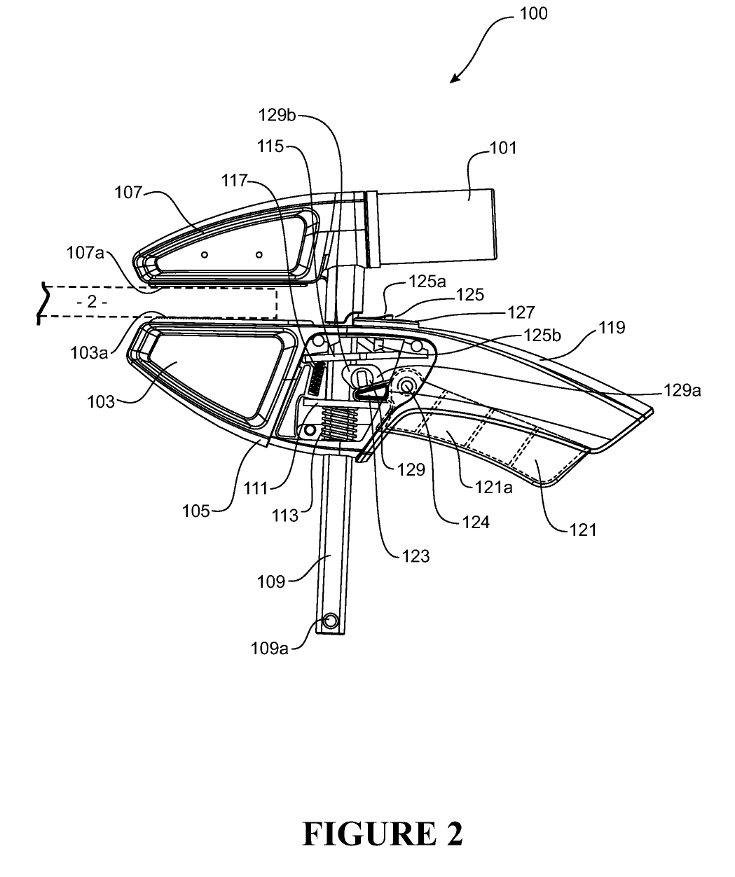

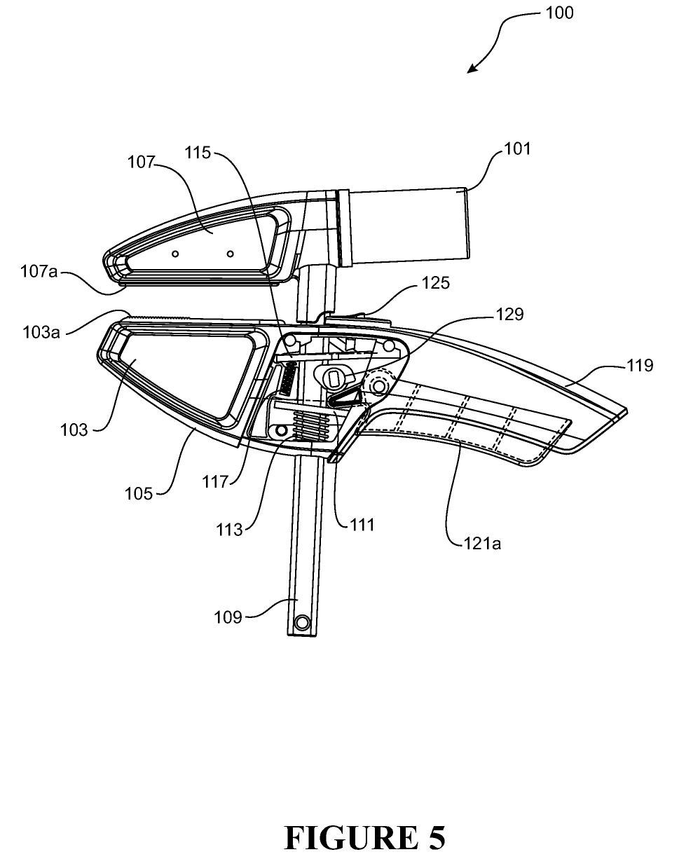

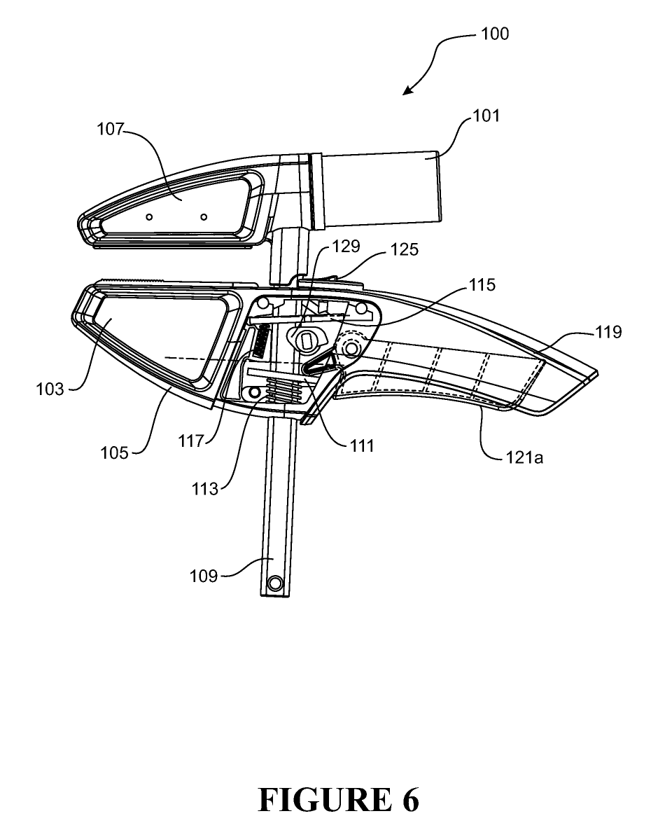

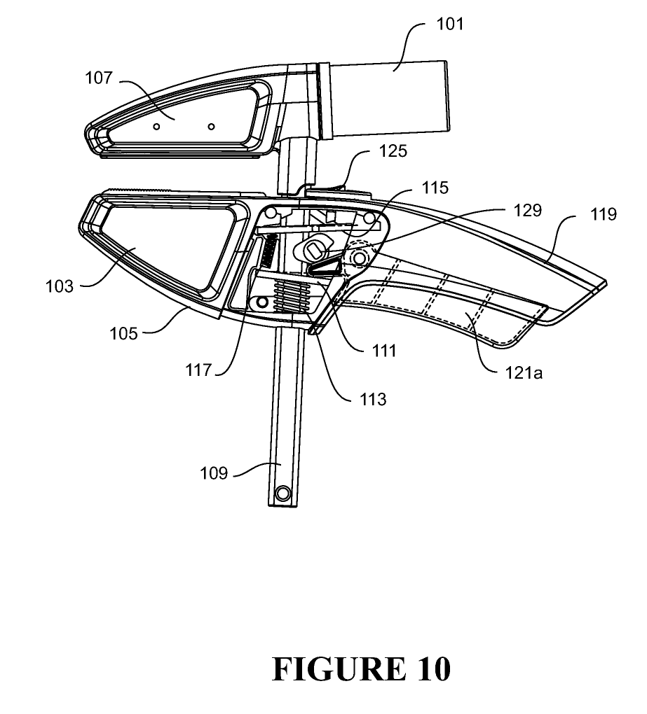

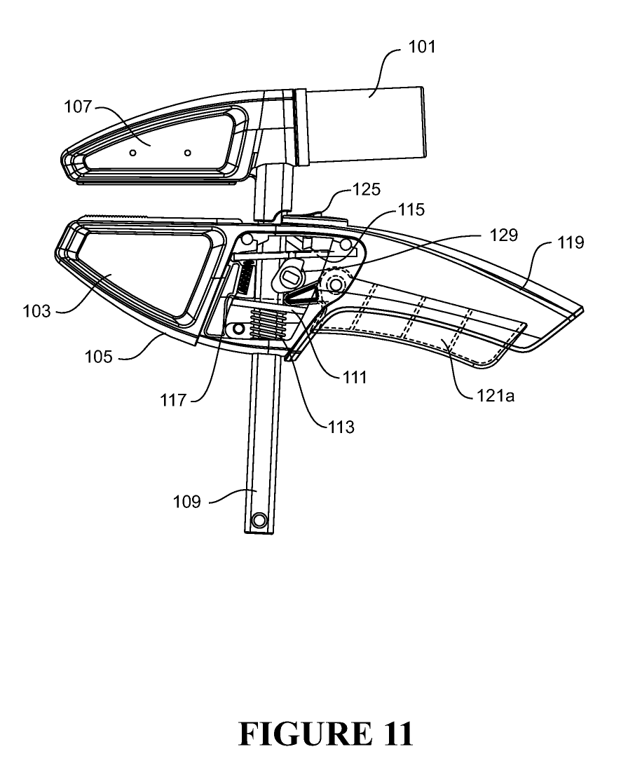

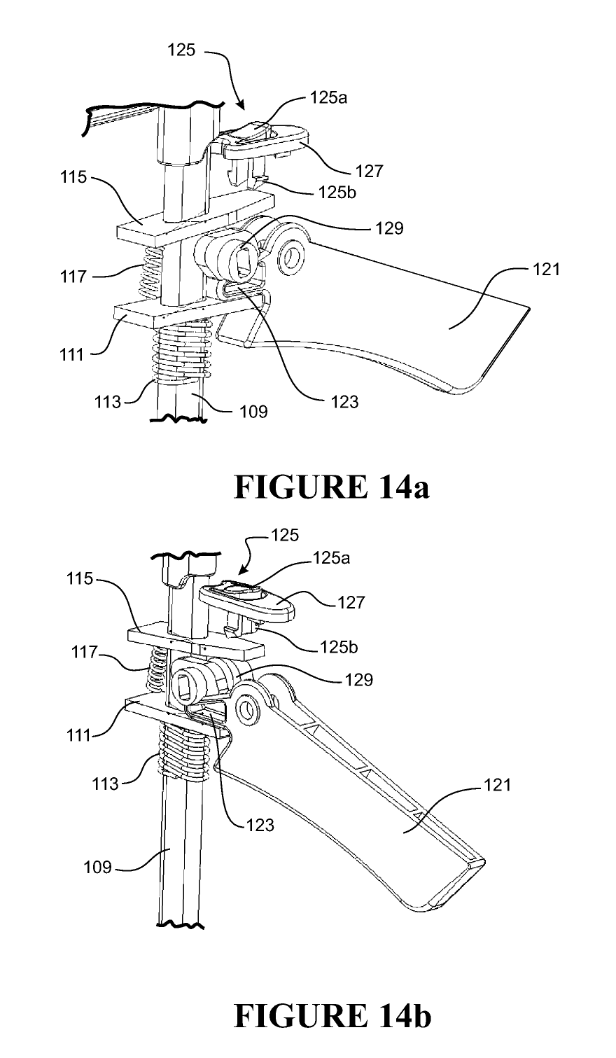

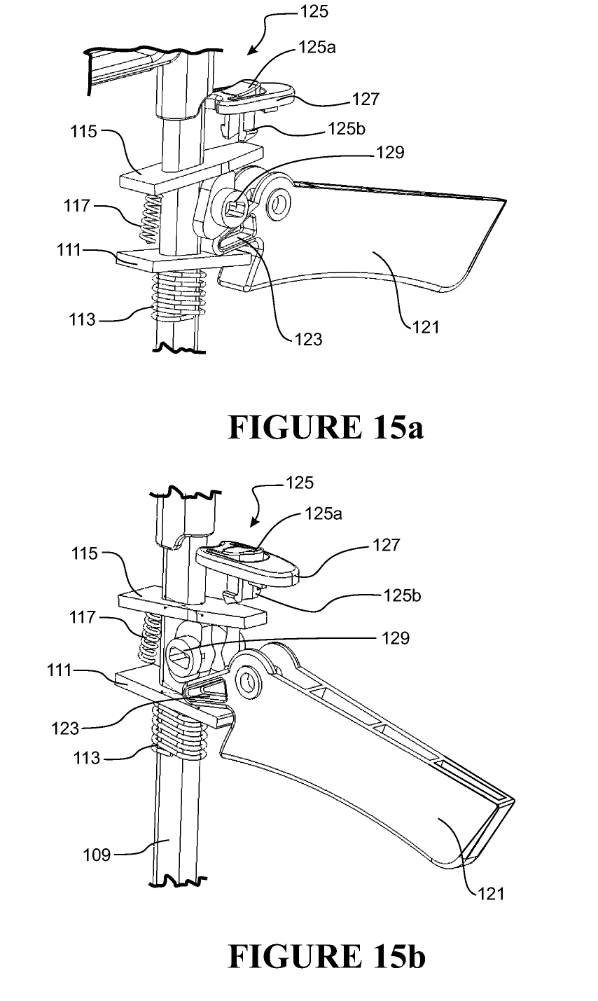

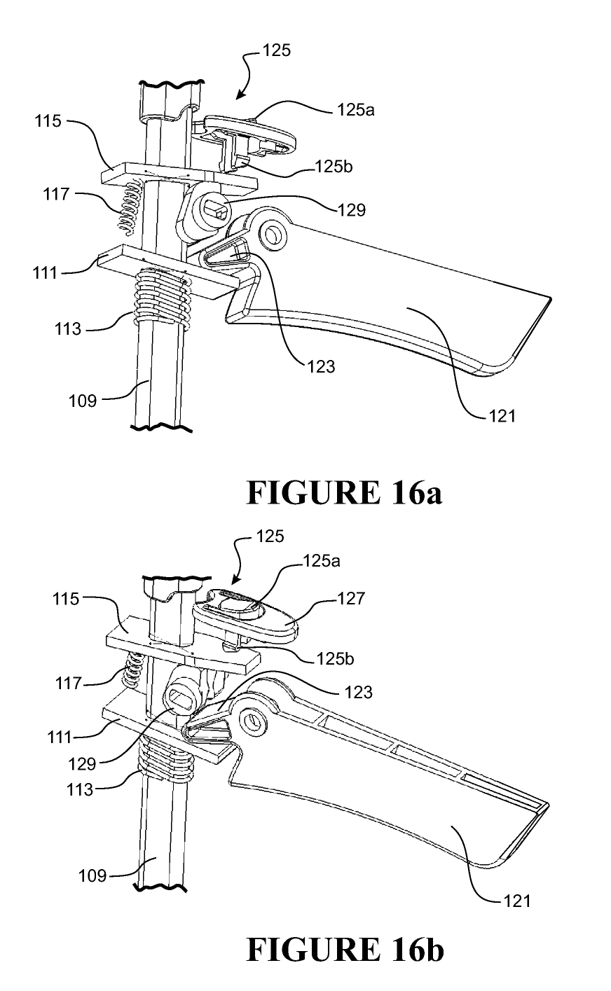

FIG. 1 shows a preferred form table-mountable high chair. The table-mountable high chair is suitable for supporting a baby, toddler, or young child from a support surface such as a table top. It could also be mounted to any other suitable surface such as a bench for example. The table-mountable high chair comprises a seat portion 1 for receiving and supporting the child, and two mounting or clamping apparatuses 100 for mounting the table-mountable high chair to a table top. The mounting apparatuses are the main supports for the high chair; it is not necessary for the high chair to separately be supported from the ground by chair legs that engage the ground for example. The mounting apparatuses 100 will be described in detail below with reference to FIGS. 2 to 19.

FIG. 2 also shows, in phantom lines, the edge of a table top 2 with one of the mounting apparatuses mounted thereto.

The table-mountable high chair has a support frame 3 which has a forwardly-open generally U-shaped configuration when viewed from above. The support frame comprises two side members 3a and a rear cross member 3b. The seat portion 1 is defined by a support fabric 5, which can be any suitable type of fabric such as a canvas for example. In the preferred form shown, the support fabric is attached to the frame by a “sail track” configuration. In particular, the support frame 3 is provided with a channel 7 that extends around the interior of the support frame and opens into an enlarged internal recess (not shown) within the support frame. One or more elongate members (not shown) are attached to the support fabric, and are received from the enlarged recesses of the support frame, to support the fabric 5 from the support frame. Any other suitable means of attachment could be used; for example domes, buttons, clips, or surrounding the support frame with the fabric, for example.

In the form shown, the fabric 5 supports a seat cushion 9a and a back cushion 9b which provide comfortable support for the child in the seat portion 1. The cushions may be separate from one another, or may be a single component. Additionally, the cushions could be permanently attached to the support fabric, or could be removable from the support fabric 5. In an alternative configuration, the seat portion may simply be defined by the frame and the fabric, with no cushion provided.

The seat portion further comprises a generally T-shaped crotch support 11 that extends between the base of the fabric and the upper forward edges of the two sides of the fabric that are in close proximity to the frame 3. The crotch support defines two leg openings 11a, 11b, so that a child can sit in the seat portion 1 with their back supported by the back cushion 9b and their legs extending through the leg openings 11a, 11b. The crotch support 11 acts as a safety feature that prevents the child from slipping out of the chair when in use. Additionally, or alternatively, the chair may be provided with a harness 13 of any suitable type that helps hold the child in position in the seat portion.

The mounting apparatuses 100 extend in a generally forward direction F from the seat portion on respective sides thereof, and are positioned such that when a child is seated in the chair the child's legs are positioned under the table top. The jaws of the mounting apparatuses are forwardly open for receipt of a support surface such as a table top. The side members 3a of the frame comprise openings at their forward ends, and the mounting apparatus 100 are mounted to the side members 3a by bosses 101 (FIG. 2) that are received in the openings of the side members. Any other suitable form of attachment could be provided.

The mounting apparatuses 100 on each side of the chair will be the same as each other, other than being mirror images of each other. Accordingly, the features and functioning of only a single mounting apparatus will be described below. Turning to FIG. 2, each mounting apparatus comprises a first lower jaw 103 that is mounted to a support 105. In the form shown, the support 105 is a housing that contains at least some of the drive mechanism of the mounting apparatus, and is substantially enclosed by a cover plate (not shown) in use. Alternatively, the support may be a more open configuration, such as a frame that supports the mechanism.

In the form shown, the first jaw 103 is integrally formed with the support, such as via a polymer moulding or metal casting process for example. Alternatively, the first jaw could be formed separately from the support, and could be attached to the support.

The mounting apparatus further comprises a second upper jaw 107 in opposed relationship with the first lower jaw 103, with an object-engaging face 103a of the first jaw facing toward an object-engaging face 107a of the second jaw. The object engaging faces are formed of a resilient and/or low friction material, such as rubber for example, to enhance gripping of the object 2 in use. An elongate bar 109 is slidably supported by the support 105, and extends through the support. The elongate bar may be solid or hollow. The second jaw 107 is mounted to the elongate bar, and the elongate bar 109 is slidable relative to the support 105 to move the first jaw 103 and second jaw 107 toward one another or away from one another. In the form shown, the second jaw 107 is separately formed from the elongate bar 109, and is attached to the elongate bar. Alternatively, the second jaw 107 and elongate bar 109 may be integrally formed, such as via a polymer moulding or metal casting process for example.

A stop (not shown) is preferably provided at the lower end of the elongate bar, to define a bottom position of the support 105 on the bar. The stop can be attached to the elongate bar via a fastener that can extend through an aperture 109a for example.

A driving lever 111 is supported by the support 105. The driving lever is selectively engageable with the elongate bar 109 and, when engaged, moves the first jaw 103 toward the second jaw 107.

The driving lever 111 is in the form of a plate that surrounds and is tiltable relative to the elongate bar 109. When the driving lever 111 is perpendicular to the elongate direction of the elongate bar 109, the driving lever 111 is disengaged from the bar, and when the driving lever is tilted relative to the elongate bar, the driving lever engages the elongate bar. The driving lever is biased toward the disengaged configuration by a biasing mechanism that in the form shown is a compression spring 113. The left end of the driving lever 111 in the figure is pivoted to the support 105, and the spring 113 biases the driving lever toward the disengaged configuration. It will be appreciated that any other type of biasing mechanism could be used, such as a leaf spring that biases the driving lever toward the disengaged position for example.

The support 105 of the mounting apparatus comprises a handle portion 119 that extends generally rearwardly from the first jaw 103. The handle portion is preferably downwardly angled as shown. A driving actuator 121 is pivoted to the support 105, and operatively engages the driving lever 111 such that when the driving actuator is operated by a user, the driving lever 111 engages the elongate bar and causes movement of the first jaw 103 toward the second jaw 107. This movement can be considered movement of the first jaws 103 in a first direction relative to the second jaw 107.

The driving actuator 121 comprises at least one projection 123 that engages the driving lever 111 to actuate the driving lever 111 such that it engages the elongate bar 109. Preferably, the driving actuator 121 comprises two spaced apart projections 123 that engage the driving lever 111 to actuate the driving lever 111 such that it engages the elongate bar 109, and the elongate bar extends through a spacing between the two projections 123. The driving actuator comprises a handle with a portion 121a sized to be engaged by a plurality of a user's fingers. The projections 123 are positioned within the support 105, with the finger engagement portion 121a of the driving actuator positioned generally externally of the support 105. As shown in FIG. 2, the finger engagement portion 121a is partly recessed in the support 105, within the handle portion 119 of the support 105. The driving actuator is pivoted to the support 105 at a driving actuator pivot 124, with the finger engagement portion 121a being positioned on one side of the pivot 124 and the projections 123 being positioned on the other side of the pivot 124.

A forwardmost exposed portion of the driving actuator 121 preferably forms a non-operational portion. A user can apply force against that non-operational portion while depressing the brake release actuator (described below), without causing movement of the driving actuator 121. That non-operational portion is provided substantially immediately adjacent the housing, substantially directly beneath the pivot 124. The non-operational portion is preferably configured so it can be differentiated from the remainder of the driving actuator 121 by touch. Accordingly, the driving actuator 121 preferably comprises a sensory or tactile indicator. For example, the non-operational portion could be flattened, raised, indented, or ribbed. Alternatively, a rib, notch, or other type of indicator may be provided between the non-operational portion and the remaining portion.

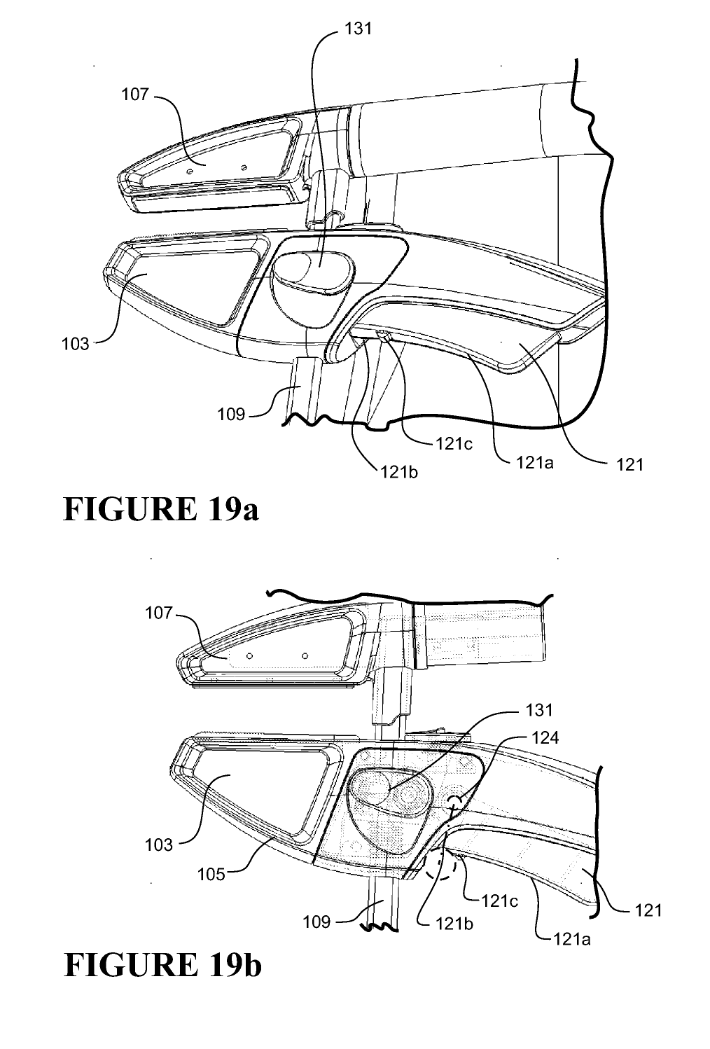

FIGS. 19a and 19b show the non-operational portion 121b, and a projection 121c that differentiates the non-operational portion 121b from the remaining portion 121a.

The driving actuator is biased into the non-operated position by spring 113, via the driving lever. Alternatively, or in addition, a driving actuator spring may be provided to bias the driving actuator into its non-operational position.

The handle portion 119 of the support 105 is positioned relative to the driving actuator 121 such that the handle portion 119 may be positioned in the region of a user's hand between the user's thumb and forefinger, with at least some of the user's fingers extending generally around the finger engagement portion 121a of the driving actuator to operate the driving actuator.

A braking lever 115 is supported by the support 105. The braking lever 115 normally engages the elongate bar 109 and, when engaged, prevents the first jaw 103 from moving away from the second jaw 107. When disengaged, the braking lever 115 enables the first jaw 103 to move away from the second jaw 107.

The braking lever 115 is in the form of a plate that surrounds and is tiltable relative to the elongate bar 109. When the braking lever 115 is perpendicular to the elongate direction of the elongate bar 109, the braking lever 115 is disengaged from the bar, and when the braking lever 115 is tilted relative to the elongate bar 109, the braking lever 115 engages the elongate bar 109. The braking lever 115 is biased toward the engaged configuration by a biasing mechanism that in the form shown is a compression spring 117. The left end of the braking lever 115 in the figure is pivoted to the support 105, and the spring 117 biases the driving lever toward the engaged configuration. It will be appreciated that any other type of biasing mechanism could be used, such as a leaf spring that biases the braking lever toward the engaged position for example.

The levers 111, 115 diverge in a direction away from the points at which they pivot to the support 105, and the projections 125 of the driving actuator are provided between the more widely spaced ends of the levers.

A brake release actuator 125 operatively engages the braking lever 115 such that when the brake release actuator 125 is operated by a user, the braking lever 115 disengages the elongate bar 109 and enables the first jaw 103 to move away from the second jaw 107. That may be considered relative movement of the jaws in a second, opposite direction to the first direction movement caused by actuation of the driving actuator 121.

The brake release actuator 125 is positioned so it can be operated by the user's thumb when the user is standing behind the high chair and holding the handle portion 119 and finger engagement portion 121a of the driving actuator 121, with their fingers extending around the finger engagement portion of the driving actuator 121.

A projection 125b extends downwardly from the thumb engagement portion 125a of the brake release actuator 125. When the brake release actuator 125 is depressed by a user's thumb, the projection 125b pushes down on the right side of the braking lever 115 shown in FIG. 2, to release the engagement of the braking lever 115 from the elongate bar 109. It will be readily apparent from FIG. 2 for example, that the projection 125b on the brake release actuator 125 need not stay in contact with the braking lever 115 at all times.

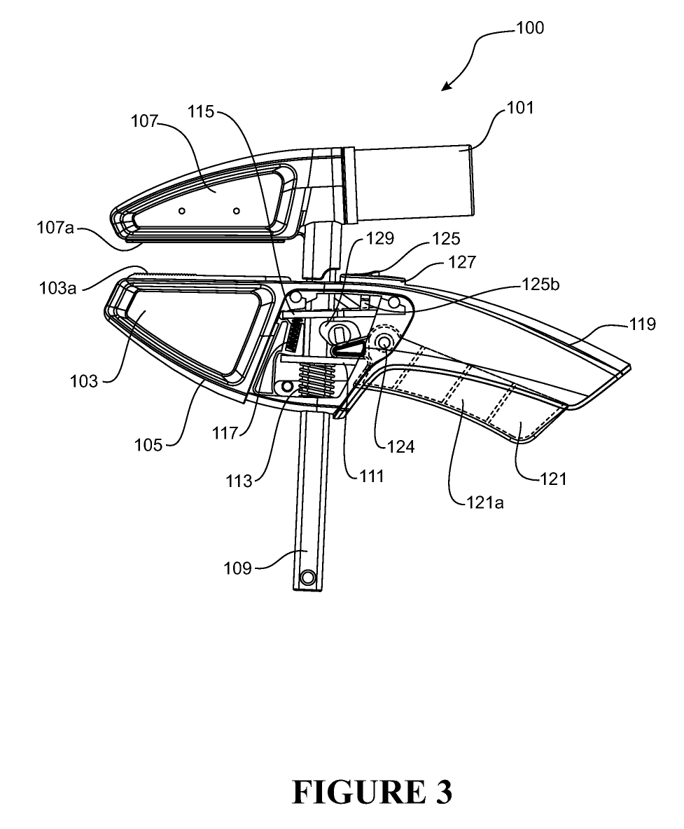

FIG. 3 shows the brake release actuator having been depressed, to make the braking lever more horizontal, so it no longer engages the elongate bar.

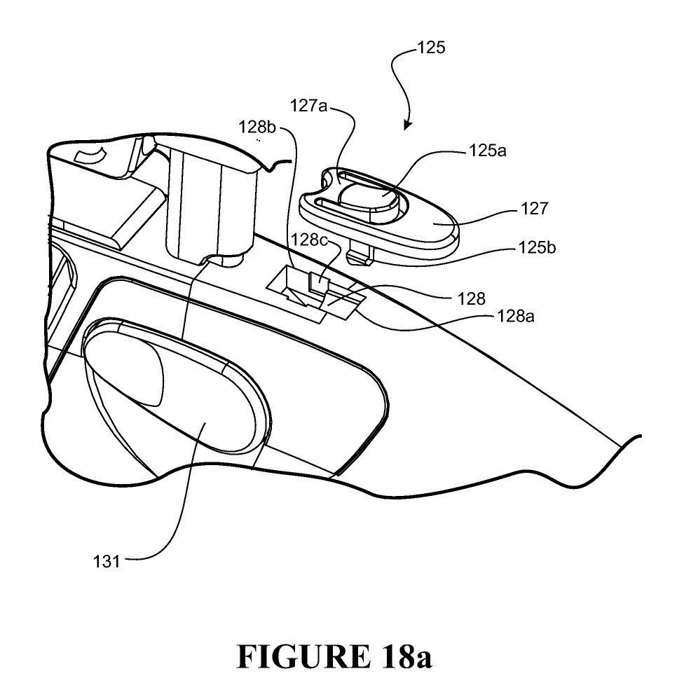

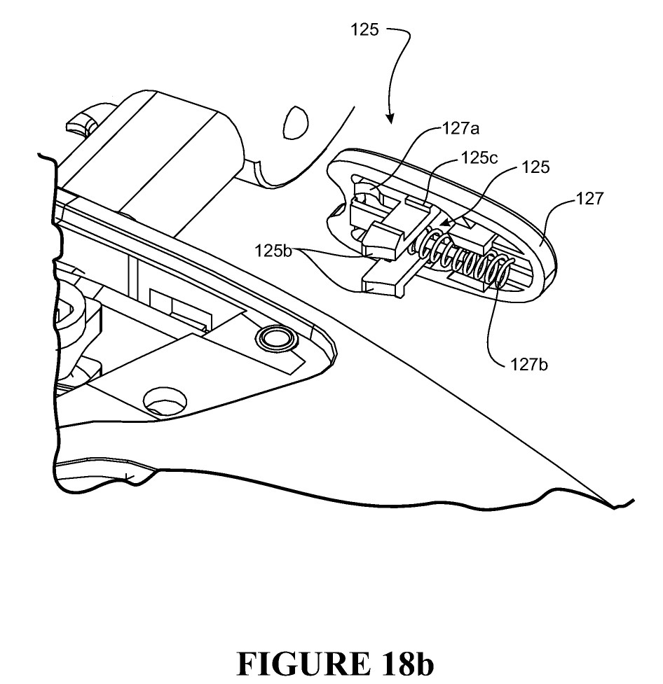

The apparatus further comprises a brake release actuator safety mechanism that prevents the brake release actuator 125 from being inadvertently actuated. Details are shown in FIGS. 18a and 18b. The brake release actuator safety mechanism causes the brake release actuator 125 to be biased into a position in which the brake release actuator 125 cannot be operated, and is manually moveable to a position in which the brake release actuator can be operated. Those correspond to a locking position and a released position of the safety mechanism respectively.

In the form shown, the brake release actuator safety mechanism is integrated into the brake release actuator, and includes a slide member 127. The brake release actuator button 125a is resiliently coupled to the slide member 127 at a resilient coupling 127a. The upper surface of the housing comprises a recess to receive the brake release actuator 125. A biasing means such as a coil spring 127b for example, biases the brake release actuator and slide member forwardly. The coil spring 127b engages against a seat 128a in the recess. When in the forward position, projections 125c are positioned above and overlap with shoulders 128b. As the projections 125c are fixed relative to the brake release actuator button, in that position the button cannot be depressed.

When the brake release actuator button 125a and slide member 127 are moved rearwardly relative to the housing against the spring bias, the projections 125c become aligned with recess enlargements 128c. In that position, the brake release actuator button 125a can be depressed, and the projections 125c will move downwardly within the enlargements 128c.

Tapered enlargements are provided on the portion 125b of the brake release actuator that engages with the braking lever when the button 125a is depressed, and maintain the brake release actuator in engagement with the support 105.

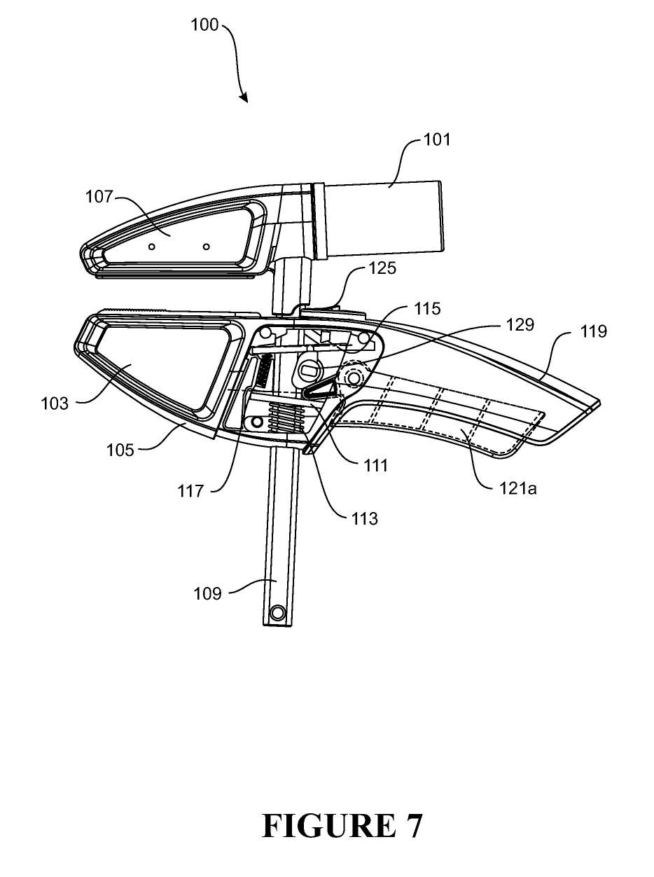

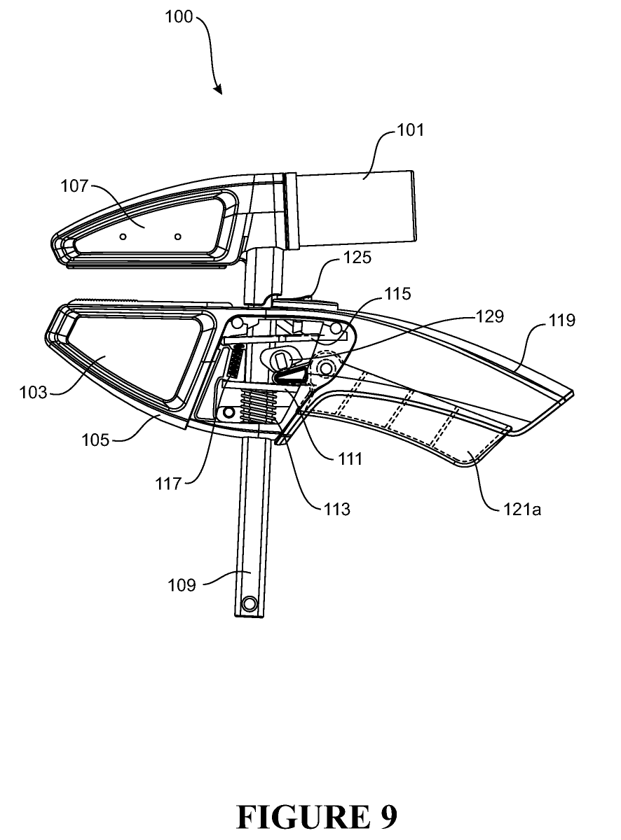

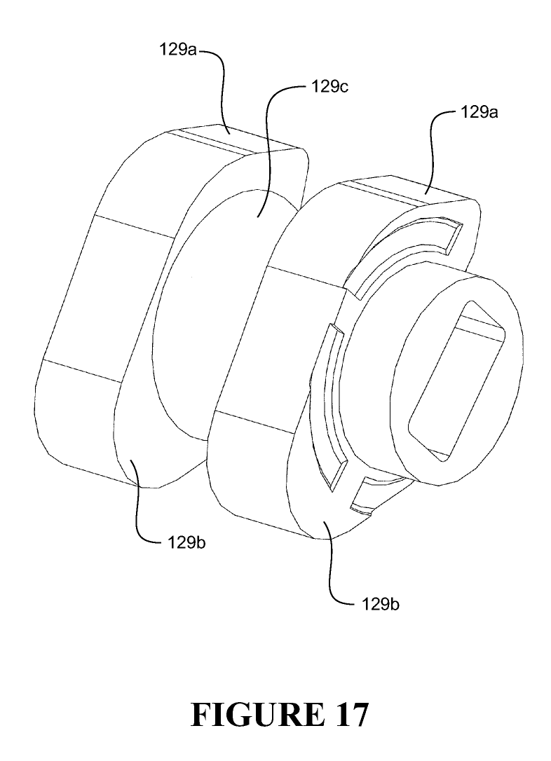

A safety lock 129 has a locked configuration and released configuration. The safety lock comprises a cam member 129 that is rotatably mounted to the support housing 105. The locked configuration of the cam member is shown in FIGS. 7, 8, 12, and 13, and the released configuration is shown in FIGS. 1, 3, 4, 5, and 6. FIGS. 9-11 show intermediate positions of the cam member. The cam member is shown in more detail in FIG. 17.

The mounting apparatus 100 comprises a safety lock actuator 131 (FIG. 1) that is positioned generally externally of the housing 105, and that is operatively connected to the cam member 129. The safety lock actuator 131 of the left mounting apparatus 100 is positioned on the left side of the support 105, so it can be operated by the user's left forefinger when the user is standing behind the high chair and holding the handle portion 119 and finger engagement portion 121a of the driving actuator 121. The safety lock actuator 131 of the right mounting apparatus 100 will be positioned on the right side of the support, so it can be operated by the user's right forefinger when the user is standing behind the high chair and holding the handle portion and finger engagement portion of the driving actuator. The positioning of the safety lock actuators is such that a user could potentially operate those with their thumbs, but use by the forefingers will be more comfortable and preferable as it enables a stronger grip on the handles.

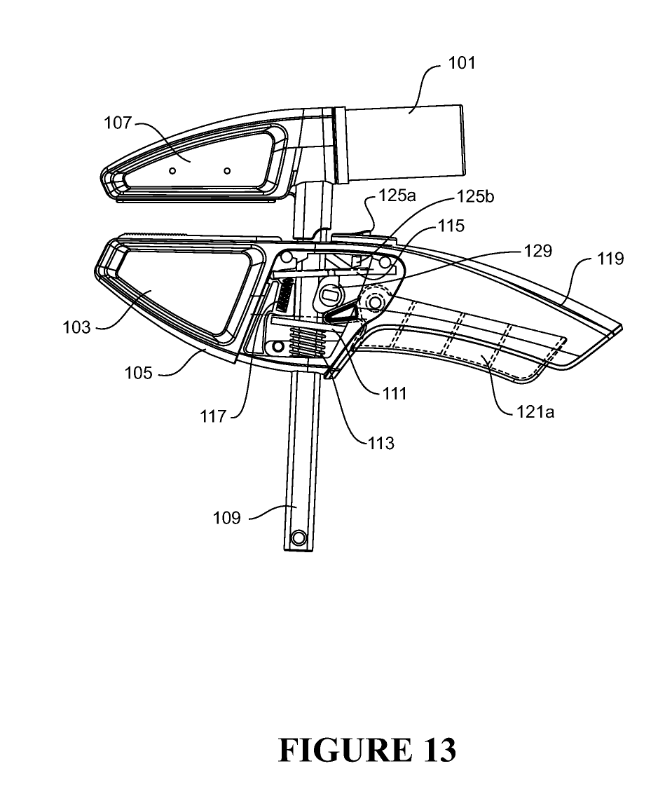

When in the locked configuration, the safety lock 129 prevents disengagement of the braking lever 115 from the elongate bar 109, by the cam member 129 engaging the underside of the braking lever 115. In that configuration (shown in FIG. 13), pressing the brake release actuator 127 will not cause the braking lever 115 to become more horizontal. The cam member 129 is disengaged from the braking lever 115 when the cam member 129 is in the released configuration, so the brake release actuator 127 can be depressed to release the braking lever 115 from the elongate bar 109.

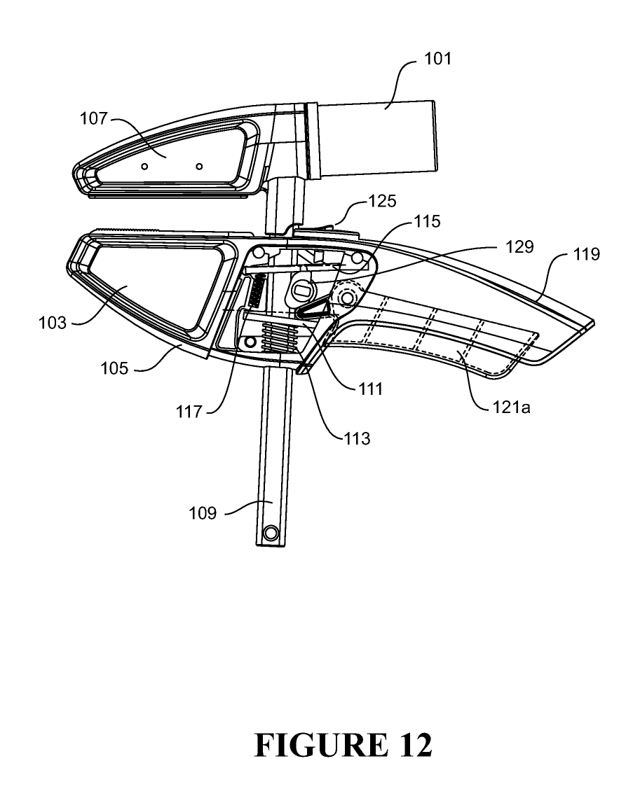

The cam member 129 comprises a pair of first lobes 129a that engage the braking lever 115 in the locked configuration of the cam member 129, and a pair of second lobes 129b that engage the projections 123 of the driving actuator in the locked position of the cam member 129 when the driving actuator 121 is not being actuated by a user. A scalloped region 129c (FIG. 17) is provided between the sides of the cam members having the lobes, so that the elongate bar 109 can extend between the lobes. The cam member is configured such that the lobes 129b engage the projections 123 of the driving actuator 121 and cause the projections 123 of the driving actuator to tilt the driving lever 111 as the cam member 129 moves to the locked configuration, to cause relative movement of the first and second jaws toward one another. Therefore, as the safety lock 129 changes from the released configuration (FIG. 2) to the locked configuration (FIG. 12) though the intermediate positions (FIGS. 9-11), the safety lock cam member 129 causes engagement of the driving lever 111 on the elongate bar 109, thereby causing movement of the first jaw 103 toward the second jaw 107.

In the form shown, the safety lock 129 may be manually adjusted between the locked configuration and the released configuration, by the user operating the safety lock actuator 131. In an alternative embodiment, the safety lock 129 may be biased into the locked configuration by any suitable biasing means, such as a torsion spring or other type of spring for example. In that embodiment, the safety lock 129 can be adjusted to the released configuration by the user operating the safety lock actuator 131, but will automatically return to the locked configuration under the bias of the spring when the safety lock actuator 131 is released.

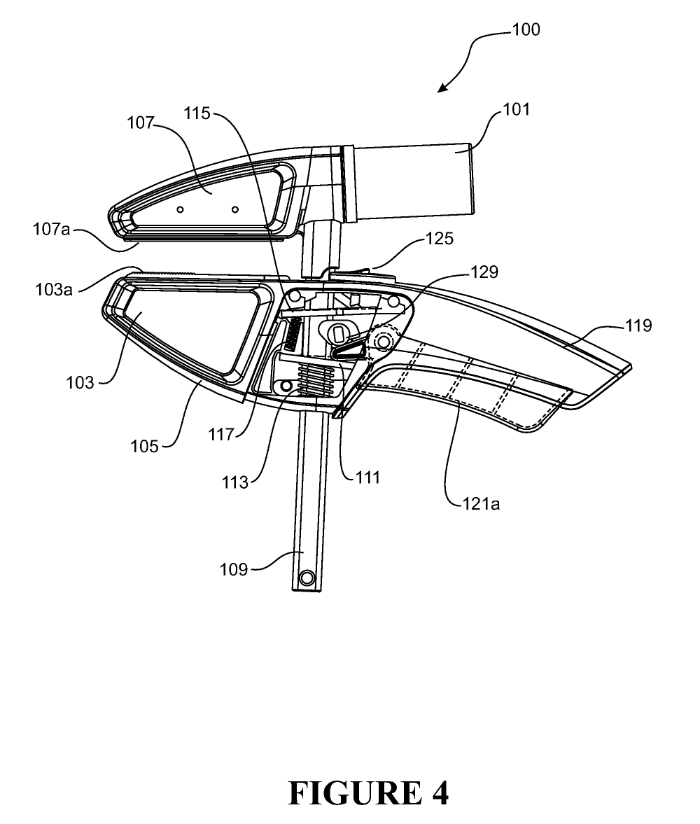

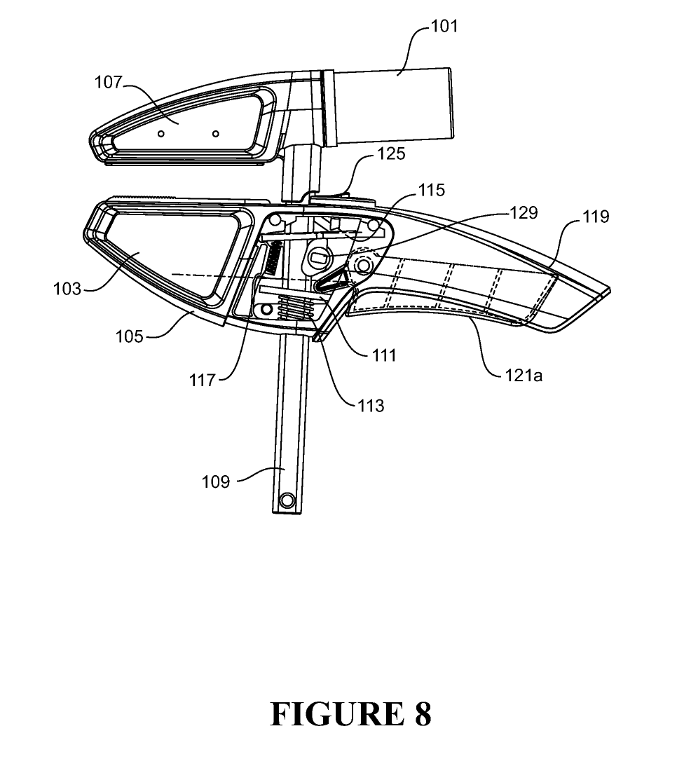

The configuration of the cam member 129, driving actuator 121, and driving lever 111 are such that the driving actuator 121 can still be operated to selectively engage the driving lever 111 with the elongate bar 109 to move the jaws toward one another, whether the safety lock 129 is in the locked position or released position. FIGS. 4-6 show the driving actuator being operated when the cam member is in the released configuration, and FIG. 8 shows the driving actuator being actuated when the cam is in the locked configuration. It can be seen that the projections 123 have moved out of contact from the cam member in FIG. 8. The driving actuator has a shorter travel when the safety lock is in the locked position.

The cam member 129 (and actuator 131) are rotatable in the support 105 through about 80 degrees. Over about the first third of rotation from the released configuration toward the engaged configuration of the cam member 129, the driving lever 111 has tilted about 2 degrees to bind on the elongate bar 109. Over about the next third of rotation of the cam member 129, the driving lever 111 is engaged on the elongate bar 109, and the first jaw 103 is moved toward the second jaw 107. For one embodiment, the amount of that movement of the jaws toward one another would typically be about 2 mm. Over the final third of rotation of the cam member 129 into the engaged configuration, the cam lobes 129a enter into a positive engagement position with the braking lever 115 and the projections 123, so that the cam member 129 will not accidentally rotate back to the released configuration. This position is similar to an over-centre drive.

The cam member is preferably positioned within the support 105 between the diverging driving lever 111 and braking lever 115.

It will be appreciated that if the driving actuator is being fully actuated (as shown in FIG. 8) when the safety lock is adjusted from the released to the locked configuration, the lobes 129b of the safety lock will not engage the projections 123 of the driving actuator and will not cause relative movement of the first and second jaws toward one another. However, if the driving actuator 121 is not being actuated by a user when the safety lock 129 is adjusted from the released configuration to the locked configuration, the adjustment of the safety lock 129 from the released to the locked configuration will cause relative movement of the first and second jaws toward one another. Accordingly, it is not necessary for the safety lock 129 to cause relative movement of the jaws in every possible configuration of the device, to be within the scope of the present invention.

The brake release actuator 125 is provided in a position away from the safety lock actuator 131. The brake release actuator 125 is provided in an upper surface of the support 105, the safety lock actuator 131 is positioned in a side surface of the support 105, and the driving actuator 121 is positioned in an under surface of the support 105.

The driving mechanism of the mounting arrangement 100 forms a one-way drive mechanism. That is, operation of the driving actuator 121 only causes the first jaw 103 and second jaw 107 to move toward one another. That movement occurs in a stepped manner. The initial part of each driving actuator compression causes the driving lever 111 to bind against the bar 109, and further compression causes the jaws to move toward one another. Following release of the driving actuator 121, the driving actuator 121 can be operated again to repeat the movement. When the driving lever 111 is disengaged from the elongate bar 109 under the bias of spring 113, the first jaw 103 can be manually moved in the first direction toward the second jaw 107 in a continuous manner. That enables a user to manually push the jaws toward one another if they wish, rather than using the driving actuator 121 to do so. For example, a user may wish to initially move the jaws toward one another quickly using that manual method, and follow that up with incremental movement of the jaws toward one another using the driving actuator 121.

The components will be made from any suitable materials. In the preferred embodiment, the springs, elongate bar, levers that engage the elongate bar, and top jaw insert will be a suitable metallic material; jaw engagement surfaces will be rubber or other elastomeric material; and the remaining components will be plastic.

In use, a user will take the preferred embodiment table-mountable high chair with the jaws in a spaced apart configuration. Generally, the user will be standing behind or beside the table-mountable high chair, and will be holding the table-mountable high chair from above by the handle portions 119 and finger engagement portions 121a of the two mounting apparatuses 100. The chair will be moved in a forward direction F so that part of a support surface 2 (such as a table top for example) is positioned between the jaws 103, 107 of each mounting apparatus 100. The upper jaws 107 may be rested against the upper surface of the support surface 2 to partly support the chair; however, that is not essential. The user will then operate the driving actuators by compressing the finger engagement portions 121a upwardly relative to the handles 119 so that the jaws capture the part of the support surface 2 between the jaws.

The user will then adjust the safety locks 129 to the locked configuration (if they are not biased into that configuration), and the step of adjusting the safety locks 129 to the locked configuration will cause the jaws to tighten further on the support surface 2 to provide additional stability. Alternatively, the safety locks 129 could be adjusted to the locked configuration before or during the operation of the driving actuators 121.

A child can then be placed in the seat portion 1 of the table-mountable chair after the table-mountable chair has been mounted to the support surface 2.

Once the child has been removed from the seat portion 1, the chair can be released from the table top 2 by operating the brake release actuators 125 to disengage the braking levers 115 from the elongate bars 109. If the safety locks 129 have been engaged, they will need to be disengaged before the brake release actuators can be used to release the chair from the table. Additionally, if the chair is provided with the brake release actuator safety mechanisms 127, the brake release actuator safety mechanisms 127 will need to be released before the brake release actuators 125 can be depressed.

The above describes preferred embodiments of the present invention only, and modifications can be made thereto without departing from the scope of the present invention.

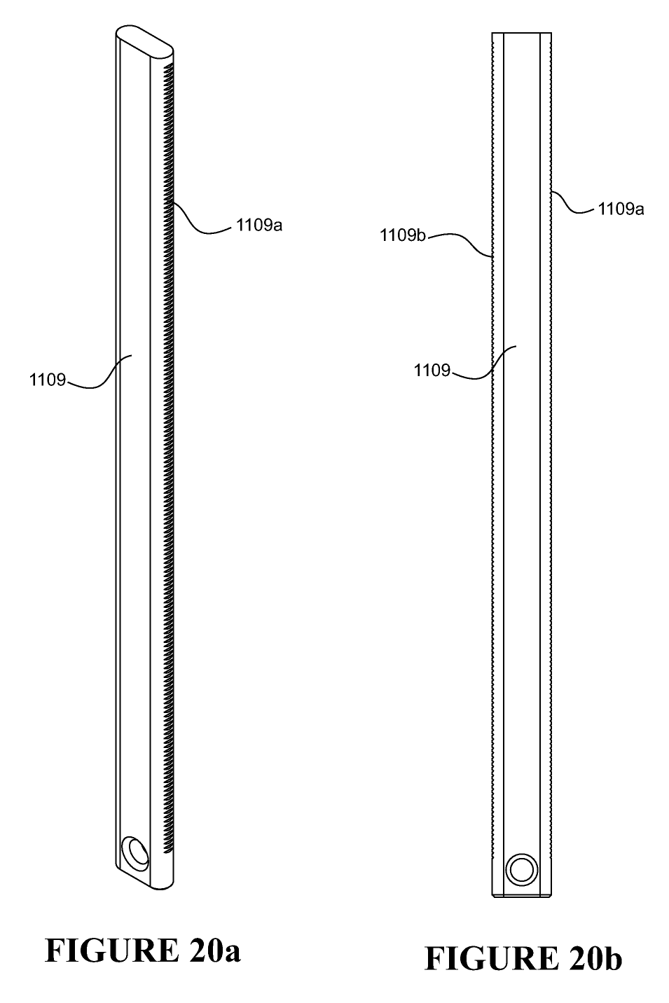

By way of example, FIGS. 20a and 20b show an alternative form elongate bar 1109 that can be incorporated into each preferred form mounting apparatus instead of elongate bar 109. Where the elongate bar 109 has smooth sides, the elongate bar 1109 has a plurality of ripples or ribs 1109a, 1109b extending along either side of the bar. The ripples or ribs 1109a, 1109b enhance the engagement between each of the braking lever 115 and the driving lever 111 with the bar 1109.

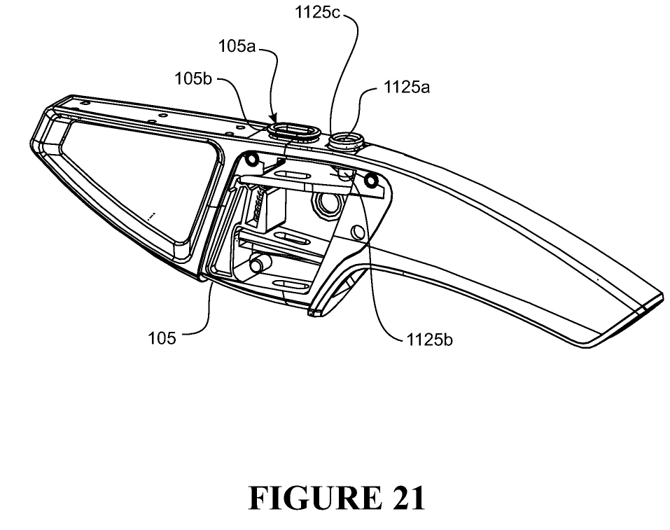

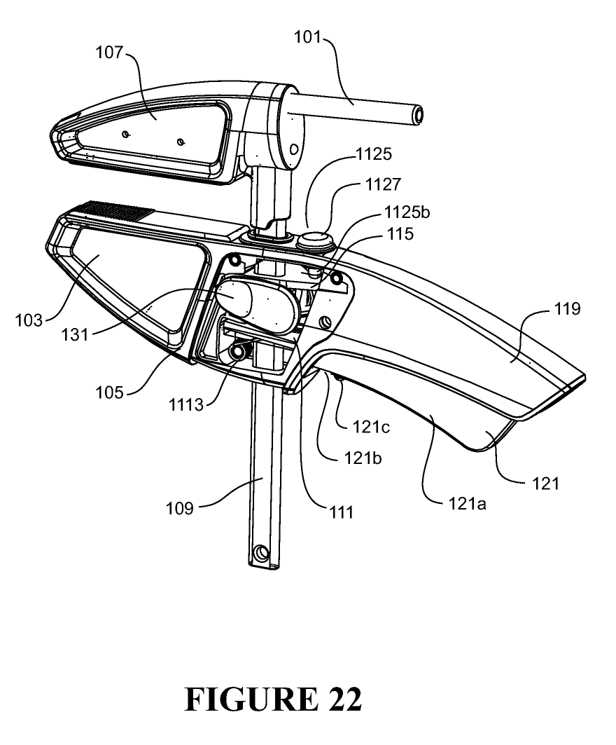

FIGS. 21 and 22 show an alternative preferred embodiment mounting apparatus. Unless described below, the features and functioning should be considered the same as described above, and like reference numerals indicate like parts. In this embodiment, the brake release actuator 1125 differs from the brake release actuator 125.

The brake release actuator 1125 again operatively engages the braking lever 115 such that when the brake release actuator is operated by a user, the braking lever 115 disengages the elongate bar 109 and enables the first jaw to move away from the second jaw.

The brake release actuator 1125 is positioned so it can be operated by the user's finger or thumb when the user is standing behind the high chair and holding the handle portion 119 and finger engagement portion 121a of the driving actuator, with their fingers extending around the finger engagement portion of the driving actuator.

A projection 1125b extends downwardly from the finger/thumb engagement portion 1125a of the brake release actuator 1125. When the brake release actuator is depressed by a user's finger or thumb, the projection 1125b pushes down on the right side of the braking lever shown in FIG. 22, to release the engagement of the braking lever 115 from the elongate bar 109. It will be readily apparent, that the projection 125b on the brake release actuator need not stay in contact with the braking lever at all times.

The finger/thumb engagement portion 1125a of the brake release actuator 1125 is positioned and recessed in a collar 1125c that is formed as part of the support 105. The recessing of the finger/thumb engagement portion 1125a stops the finger/thumb engagement portion 1125a from being depressed too easily.

The apparatus further comprises a brake release actuator safety mechanism or device 1127 shown in FIG. 22 that prevents the brake release actuator 1125 from being inadvertently actuated. In this embodiment, the brake release actuator safety mechanism 1127 comprises a protective cap the covers the finger/thumb engagement portion 1125a, to stop that from being depressed by a child in the chair.

A portion of the protective cap is mounted on a boss 105a on the support. The boss has a shoulder 105b that maintains the protective cap in place on the support 105. The elongate bar 109 extends through the boss 105a.

The protective cap is preferably made from a material that has sufficient rigidity, at least in the region covering the finger/thumb engagement portion 1125a, that the protective cap needs to be moved away from the finger/thumb engagement portion for the finger/thumb engagement portion to be depressed to release the braking lever from engagement with the elongate bar.

The intermediate portion of the protective cap between the boss 105a and the collar 1125c is preferably sufficiently resilient or flexible that the portion that covers the finger/thumb engagement portion 1125a can be lifted to provide access to the finger/thumb engagement portion 1125a. It is preferred that the intermediate portion is resilient, so the cover will automatically return to cover the finger/thumb engagement portion of the brake release actuator when a user removes lifting force from the cover. The cover may be made from any suitable material, such as rubber for example.

This embodiment also differs in that a torsion spring 1113 biases the driving lever 1111 toward the disengaged position, instead of the coil spring 113 in the above embodiment. The torsion spring is mounted on a pin in the support 105. A coil spring biases the braking lever as described for the above embodiment.

The invention is generally described with respect to mounting apparatuses for a table-mountable chair. However, the invention also has application to other technology areas. The apparatuses described above may be stand alone devices such as a hand tool. More particularly, the apparatuses may be hand-held clamps for use in a workshop for example. Alternatively, the apparatuses may be substrate-mounted tools, such as bench clamps for use in a workshop for example. In the case of a substrate-mounted tool, part of the apparatus (such as one of the jaws for example) may be formed by the substrate rather than being an additional component. The apparatuses can be used for clamping one or more objects.

The mounting apparatuses are described as having opposed 103, 107 jaws with inwardly facing object-engaging surfaces 103a, 107a. Instead, the mechanism could be incorporated into a clamp that is designed to clamp against two spaced apart object surfaces. In that configuration, the first and second jaws will be outwardly directed relative to one another, with an object-engaging face of the first jaw facing away from an object-engaging face of the second jaw. To achieve that, the jaw 107 that is mounted to the bar 109 could be mounted to the lower end of the bar rather than the upper end of the bar, and the one-way drive mechanism would cause the (now) lower jaw to move away from the upper jaw.

The configurations of components could be varied. For example, the safety lock is described and shown as a cam member. However, the safety lock could be a different configuration, such as some type of elongate component that acts on the braking lever and projections of the driving actuator when in the locked configuration.

The driving lever may comprise two plates positioned on top of each other, rather than a single plate. The lever may be actuated in the same way as outlined herein, but having two driving plates will provide four grabbing points on the elongate bar rather than two grabbing points.

The braking lever may comprise two plates positioned on top of each other, rather than a single plate. The lever may be actuated in the same way as outlined herein, but having two braking plates will provide four grabbing points on the elongate bar rather than two grabbing points.

The driving actuator is described and shown as having a portion of sufficient length that a user can operate that with several fingers. As another example, the driving actuator could be a shorter length in a trigger-type configuration with the handle, so it can be readily operated by a single finger.

What is claimed is:

1. An apparatus for clamping one or more objects, the apparatus comprising:
a support;
a first jaw mounted to the support;
an elongate bar;
a second jaw mounted to the elongate bar, wherein the elongate bar is slidable relative to the support to move the first jaw and second jaw toward one another or away from one another;
a driving lever supported by the support and that is selectively engageable with the elongate bar and that, when engaged, moves the first jaw in a first direction relative to the second jaw;
a braking lever supported by the support and that normally engages the elongate bar and that, when engaged, prevents the first jaw from moving in a second direction opposite to said first direction relative to the second jaw and that, when disengaged, enables the first jaw to move in said second direction relative to the second jaw;
a driving actuator that operatively engages the driving lever such that when the driving actuator is operated by a user, the driving lever engages the elongate bar and causes movement of the first jaw in the first direction relative to the second jaw;
a brake release actuator that operatively engages the braking lever such that when the brake release actuator is operated by a user, the braking lever disengages the elongate bar and enables the first jaw to move in said second direction relative to the second jaw; and
a safety lock having a locked configuration and released configuration, the safety lock when in the locked configuration preventing disengagement of the braking lever from the elongate bar, and being configured such that as the safety lock changes from the released configuration to the locked configuration, the safety lock causes engagement of the driving lever on the elongate bar, thereby causing movement of the first jaw in the first direction relative to the second jaw.

2. An apparatus as claimed in claim 1, wherein the first and second jaws are in opposed relationship, with an object-engaging face of the first jaw facing toward an object-engaging face of the second jaw, and wherein the first direction is relative movement of the jaws toward one another, and the second direction is relative movement of the jaws away from one another.

3. An apparatus as claimed in claim 1, wherein the first and second jaws are outwardly directed relative to one another, with an object-engaging face of the first jaw facing away from an object-engaging face of the second jaw, and wherein the first direction is relative movement of the jaws away from one another, and the second direction is relative movement of the jaws toward one another.

4. An apparatus as claimed in claim 1, wherein the driving actuator comprises two spaced apart projections that engage the driving lever to actuate the driving lever such that it engages the elongate bar, and the elongate bar extends through a spacing between the two projections.

5. An apparatus as claimed in claim 1, wherein the safety lock comprises a cam member that is rotatably mounted to the support.

6. An apparatus as claimed in claim 5, wherein the cam member engages the braking lever such the braking lever cannot disengage the elongate bar, when the cam member is in the locked configuration.

7. An apparatus as claimed in claim 5, wherein the cam member engages with a projection of the driving actuator, and is configured such that the projection of the driving actuator tilts the driving lever as the cam member moves to the locked configuration, to cause relative movement of the first and second jaws in the first direction.

8. An apparatus as claimed in claim 5, wherein the configuration of the cam member, driving actuator, and driving lever are such that the driving actuator can be used to selectively engage the driving lever with the elongate bar to move the jaws in the first direction relative to one another, whether the cam member is in the locked configuration or released configuration.

9. An apparatus as claimed in claim 5, wherein the cam member comprises a first lobe that engages the braking lever in the locked configuration of the cam member, and a second lobe that engages the driving lever in the locked configuration of the cam member, when the driving actuator is not being operated.

10. An apparatus as claimed in claim 5, comprising a safety lock actuator that is positioned generally externally of the housing, and that is operatively connected to the cam member, and wherein the safety lock actuator comprises a lever that is operable by a user's forefinger when at least some of the user's remaining fingers generally surround a finger engagement portion of the driving actuator.

11. An apparatus as claimed in claim 1, wherein the brake release actuator is positioned such that it is operable by a user's thumb when the user's fingers generally surround a finger engagement portion of the driving actuator.

12. An apparatus as claimed in claim 11, wherein the driving actuator is provided with a non-operational portion against which force can be applied while operating the brake release actuator, without causing movement of the driving actuator.

13. An apparatus as claimed in claim 1, further comprising a brake release actuator safety mechanism that prevents the brake release actuator from being inadvertently operated.

14. A table-mountable chair, comprising:
a seat portion for receiving and supporting a child;
and two mounting apparatuses for mounting the table-mounted chair to a table top, each mounting apparatus comprising:
a support;
a first jaw mounted to the support;
an elongate bar;
a second jaw mounted to the elongate bar, wherein the elongate bar is slidable relative to the support to move the first jaw and second jaw toward one another or away from one another;
a driving lever supported by the support and that is selectively engageable with the elongate bar and that, when engaged, moves the first jaw toward the second jaw;
a braking lever supported by the support and that normally engages the elongate bar and that, when engaged, prevents the first jaw from moving away from the second jaw and that, when disengaged, enables the first jaw to move away from the second jaw;
a driving actuator that operatively engages the driving lever such that when the driving actuator is operated by a user, the driving lever engages the elongate bar and causes movement of the first jaw toward the second jaw;
a brake release actuator that operatively engages the braking lever such that when the brake release actuator is operated by a user, the braking lever disengages the elongate bar and enables the first jaw to move away from the second jaw; and
a safety lock having a locked configuration and released configuration, the safety lock when in the locked configuration preventing disengagement of the braking lever from the elongate bar, and being configured such that as the safety lock changes from the released configuration to the locked configuration, the safety lock causes engagement of the driving lever on the elongate bar, thereby causing movement of the first jaw toward the second jaw.

15. A table-mountable chair as claimed in claim 14, wherein the mounting apparatuses extend in a generally forward direction from the seat portion on respective sides thereof, with the jaws being forwardly open for receipt of a support surface.

16. A table mountable chair as claimed in claim 15, wherein the driving actuators extend in a generally rearward direction.

17. A table mountable chair as claimed in claim 14, wherein the mounting apparatuses are positioned such that when a child is seated in the chair the child's legs are positioned under the support surface.

18. A table-mountable chair as claimed in claim 14, wherein in each mounting apparatus, the safety lock comprises a cam member that is rotatably mounted to the support.

19. A table-mountable chair as claimed in claim 18, wherein in each mounting apparatus, the cam member engages with a projection of the driving actuator, and is configured such that the projection of the driving actuator tilts the driving lever as the cam member moves to the locked configuration, to cause relative movement of the first jaw toward the second jaw.

20. A table-mountable chair as claimed in claim 18, wherein in each mounting apparatus, the configuration of the cam member, driving actuator, and driving lever are such that the driving actuator can be used to selectively engage the driving lever with the elongate bar to move the first jaw toward the second jaw, whether the cam member is in the locked configuration or released configuration.
